(19) United States
(12) Patent Application Publication
(10) Pub. No.: US 2014/0342600 A1
(43) Pub. Date: Nov. 20, 2014

(54) AUTOMOTIVE ADAPTER WITH CORD RETAINER

(71) Applicant: Premier Accessory Group LLC, Long Island City, NY (US)

(72) Inventor: Alfred ESSES, Brooklyn, NY (US)

(73) Assignee: Premier Accessory Group LLC, Long Island City, NY (US)

(21) Appl. No.: 13/953,898

(22) Filed: Jul. 30, 2013

Related U.S. Application Data
(60) Provisional application No. 61/824,584, filed on May 17, 2013.

(51) Int. Cl. B60N 3/14

(52) U.S. Cl. CPC B60N 3/14
USPC 439/527

(57) ABSTRACT

An automotive adapter includes a adapted to be inserted into the accessory socket of a motor vehicle. A cord can be hard wired or attachable to the body. The body is formed with a tab at one end, the tab including a hole sized and shaped to hold and secure a portion of the cord, thereby preventing the cord from interfering with the operation of the motor vehicle.

### RELATED APPLICATIONS

This application claims priority to U.S. provisional application Ser. No. 61/824,584 filed May 17, 2013 and incorporated herein by reference in its entirety.

### BACKGROUND OF THE INVENTION

A. Field of Invention

This invention pertains to an automotive adapter that plugs into the accessory socket of an automotive vehicle and includes an integral cord retainer engaging a portion of a cord extending from the socket to the device being powered.

B. Background of the Invention

Historically, motor vehicles have been provided with cigarette lighters, and, although these lighters are used for their designated purpose relatively infrequently, motor vehicles are still provided with such sockets because they have become a convenient means of providing power for various accessories in use, such as GPS devices, devices for playing music, etc. In addition, the sockets are also used for for charging various portable electronic devices that otherwise may run out of power and become useless.

A problem with existing adapted is that the cords connecting the adapter to the device being powered are not secured properly and extend haphazardly through the vehicle cabin. Therefore, these cords can get entangled with various control members in the cabin and interfere with the normal operation of the motor vehicle, For example, frequently, accessory sockets are disposed somewhere in a central or middle position on, or just below the motor vehicle dashboard, not too far from the transmission or other control element controlling the operation of the motor vehicle. As a result, when an adapter is inserted into the accessory socket, the cord connecting the adapter to a hand-held device can be entangle easily around the transmission or directional handle and interfere with its operation.

Therefore, there is a need for adapter and a cord that is secured to the adapter within the cabin so that it does not interfere with other operational elements of the motor vehicle and become a safety hazard.

### SUMMARY OF THE INVENTION

An automotive adapter constructed in accordance with this invention includes a cylindrical body sized and shaped to fit into the accessory socket of a vehicle. The including connecting elements adapted to connect to battery terminals in the accessory socket and an output member for coupling to a charging cord extending to the device that needs to be charged. A tab is supported by said body, and is arranged and constructed to receive and secure the cord.

The cord can have a flat cross section (e.g., it can be ribbon cord) or can have a generally round cross section. The tab is formed with an elongated hole having central portions. The hole is shaped and sized so that it form an interference fit with either the ribbon cable or the round cable, and hence can retain cable having either type of cross-section.

In one embodiment, the adapter includes two jacks that may be identical or may be different in that they may be arranged and constructed to either accept different plugs or deliver power at different voltages and/or current to the respective devices. For this embodiment, the adapter is also provided with a tab. The tab can be shaped so that it can accommodate one or two cords. Alternatively, the adapter is provided with two different tabs, each accommodating a respective cord.

Disposed within the body of the adapter, there is an electronic circuit that performs all the functions necessary to power the devices connected to it and/or charge these devices. The circuit includes a conditioning section, a voltage and current control section and a dedicated charging port control section.

The condition section is connected to the automotive battery and protects the circuit from power surges and other spurious and momentary signals.

The voltage and current control section generates an output signal at a precise voltage and current appropriate for charging certain devices. This section may be a dual channel device to generate two different outputs, both having highly regulated outputs.

The dedicated charging port control section includes an IC that monitors the control signals from the respective device and insures that the data lines are biased appropriately for charging the respective device(s).

### BRIEF DESCRIPTION OF THE DRAWINGS

FIG. 1 shows an orthogonal view of an automotive adapter with a ribbon cord constructed in accordance with this invention;

FIG. 2 shows a rear view of the automotive adapter of FIG. 1;

FIG. 2A shows an enlarged plan view of the tab for the adapter of FIGS. 1, 2;

FIG. 3 shows a side view of the automotive adapter of FIG. 1;

FIG. 4 shows a rear view of the automotive adapter with a round cord; and

FIG. 5 shows an orthogonal view of an adapter with two outlets; and

FIG. 6 shows a circuit diagram for the embodiment of FIG. 5.

### DETAILED DESCRIPTION OF THE INVENTION

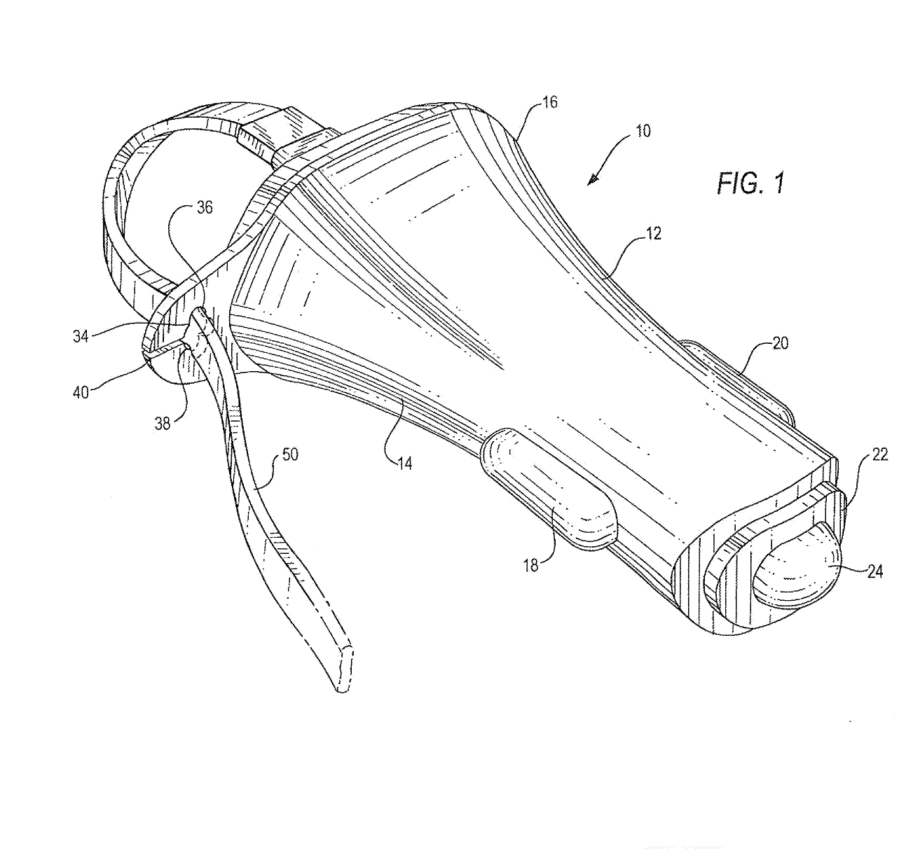

As shown in FIG. 1, an automotive adapter 10 constructed in accordance with this invention includes a body 12 with an outer wall 14 having a somewhat oval cross-section. More specifically, the outer wall 14 can have a circular, elliptical or any other similar cross section. In the embodiment shown, the rear portion of the outer wall 14 flares radially outwardly, as at 16.

Outer wall 14 supports two metallic contacts 18, 20 that are connected to the ground terminal of vehicle when the adapter 10 is inserted into an accessory socket (not shown). Preferably one or both contacts are spring loaded. Alternatively, one of the contacts 18, 20 may be omitted or may be replaced by an element that is not connected to the vehicle battery, or may be made of a non-metallic element, but provided as a means of retaining the adapter 10 securely within the accessory socket.

The body 12 further includes a front end 22. A rounded pin 24 extends outwardly of the front end 22 as shown and is also preferably spring loaded. That is, pin 24 can be pushed inward but springs axially outwardly when released. Conventionally, the pin 24 is connected to the positive terminal of the motor vehicle battery (not shown) through a contact and an appropriate wire when the adapter 10 is inserted into an accessory socket.

Body 12 further includes a rear wall 26. An indicator light 28 may be provided on this wall 26 as shown. Alternatively, light 28 is mounted elsewhere on the body 12, such as, for example, the outer wall 14. Rear wall 26 further supports in one embodiment a standard jack 30. For example, this jack may be a mini- or micro USB connector jack, or any other type of connector suited for interfacing with a hand-held device.

On one side, the rear wall 26 is formed with a tab 32. The tab is flat, has a thickness of about 1/16- 3/16 in and is somewhat flexible. In one embodiment, both the rear wall 26 and tab 32 are generally flat and coplanar.

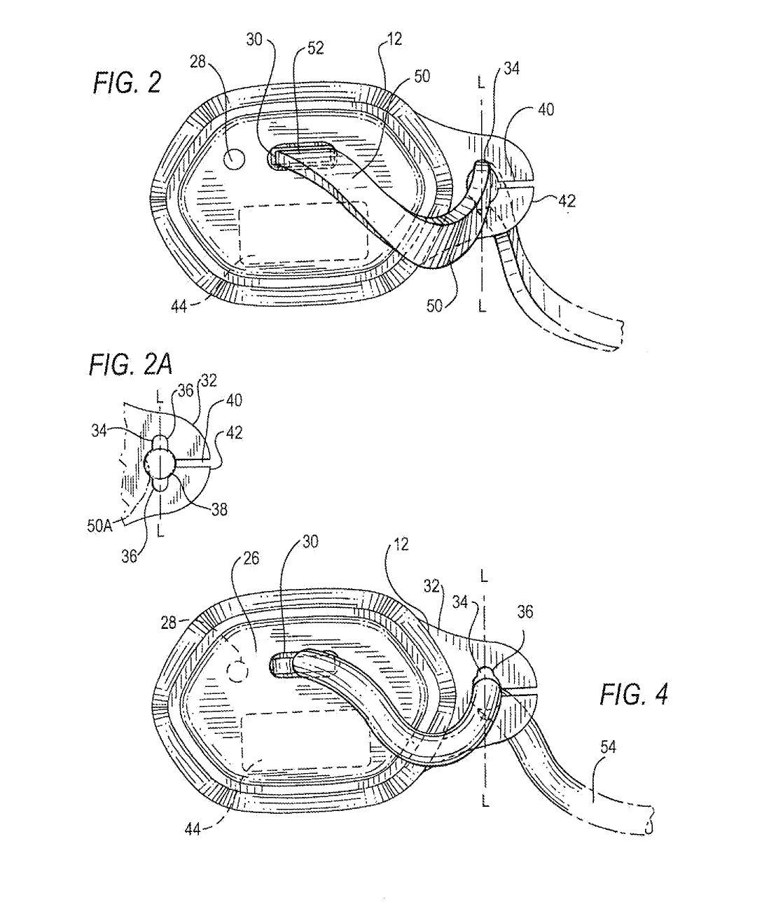

Details of the tab 32 are seen in FIG. 2A. The tab 32 is formed with a hole 36. Preferably, hole 36 is not circular but is elongated with two end sections 36 so that it has a major axis L-L that is parallel with the outer wall 12. The minor axis of the hole 34 is normal to surface 14. The hole 34 has a central portion 38 that is preferably with end sections 36 being positioned in diametrically opposite positions end extending radially away from central portion 38. A narrow slit 40 extends from an outer edge 42 of the tab 32 to opening 34. Slit 40 is normal or perpendicular to outer wall 14.

As previously mentioned, the adapter 10 is constructed and arranged so that its body 12 can be inserted into a standard (nominal) 12 volts DC automobile socket, with pin 24 being connected to a wire (not shown) which is electrically coupled to the positive terminal of an automotive battery (not shown). One or both contacts 18, 20 are connected to the automotive ground and, because they are spring loaded, they also form a friction fit to keep the adapter 10 within the automotive socket (not shown).

An electronic circuit 44 is embedded into body 12. The circuit 44 is electrically connected to one of the contacts 18, 20 and pin 24, and includes voltage step-down circuitry, voltage regulation circuitry, optional current protection elements, optional surge protection elements etc., necessary to provide a controlled 5 volt DC output from the car battery as described in more detail below. The light 28 is activated when the circuit 44 is on and providing a current through the cord 50 to show that the adapter 10 is operational.

A cord 50 has at one a plug 52 connected to jack 30. The other end 54 leads to the device to be powered. In one embodiment, the plug 52 and jack 30 are eliminated and the cord 50 is hardwired into the adapter 10.

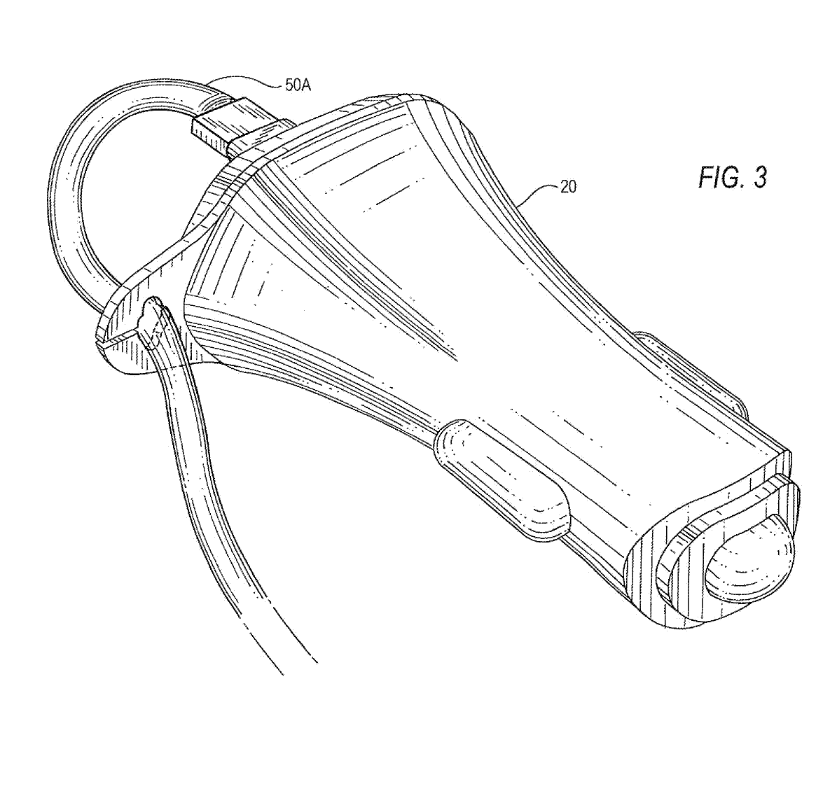

In the embodiment shown in FIGS. 2 and 3, the cord 50 is a flat ribbon having a width much larger than its thickness. It has been found that this kind of cord is less likely to get tangled and is easier to use. Importantly, the extensions 36 define a generally rectangular opening along axis L-L that is approximately the same or slightly smaller than the width and a thickness as the cord 50. In this manner, end sections 36 of hole 34 are sized and shaped to form a friction fit that holds the cord 50 in place when inserted into hole 34. The cord 50 can be threaded into the hole 34 or it can be inserted through slit 40.

When the adapter 10 is inserted into the accessory socket of a motor vehicle, the tab 32 secures the cord 50 as shown in FIG. 3 and prevents it from interfering with the operation of the vehicle. In other words, the tab 32 acts as a retainer for the cord.

As mentioned above, the cord 50 preferably is ribbon shaped. However, in an alternate embodiment, a cord 50A may be used that can have a somewhat circular cross-section instead, as shown in FIG. 4. For this configuration, the cord 50A is secured by the central, round sections 38 of hole 34.

The body 12 can be made in any conventional way, such as molding, with the tab being made as an integral piece therewith.

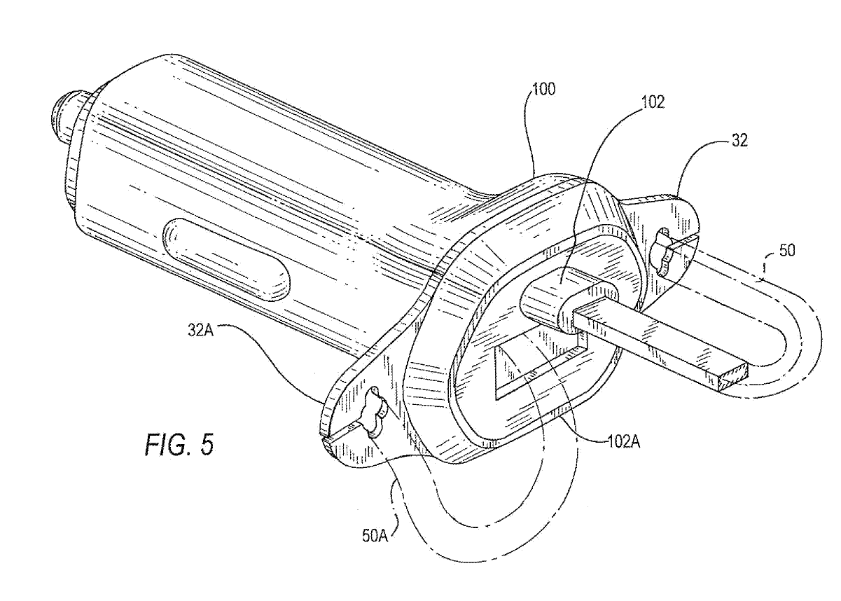

FIG. 5 shows another embodiment in which adapter is provided with two jacks 102, 102A are provided. The two jacks may be identical or may be different. For example jack 102 may be a microUSB jack or a connector suitable for connecting to Apple® devices such as a Lightning cable. The second jack 102A could be a standard USB jack. Preferably electronic circuitry within the body is configured to use the unregulated battery voltage from the automobile as an input and convert it to a controlled 5v output with a total current capability of up to 4.8 amps so that the device can be used to power devices requiring high charging currents, such as Ipads® and other tablets. Since there are two jacks provided on the adapter 100, tab 32 may be enlarged so that it can accept two cords, one leading to each jack. For example, the tab 32 may be provided with two holes 38. Alternatively adapter 100 may be provided with two cord retaining tabs 32, 32A, one on each side, as shown.

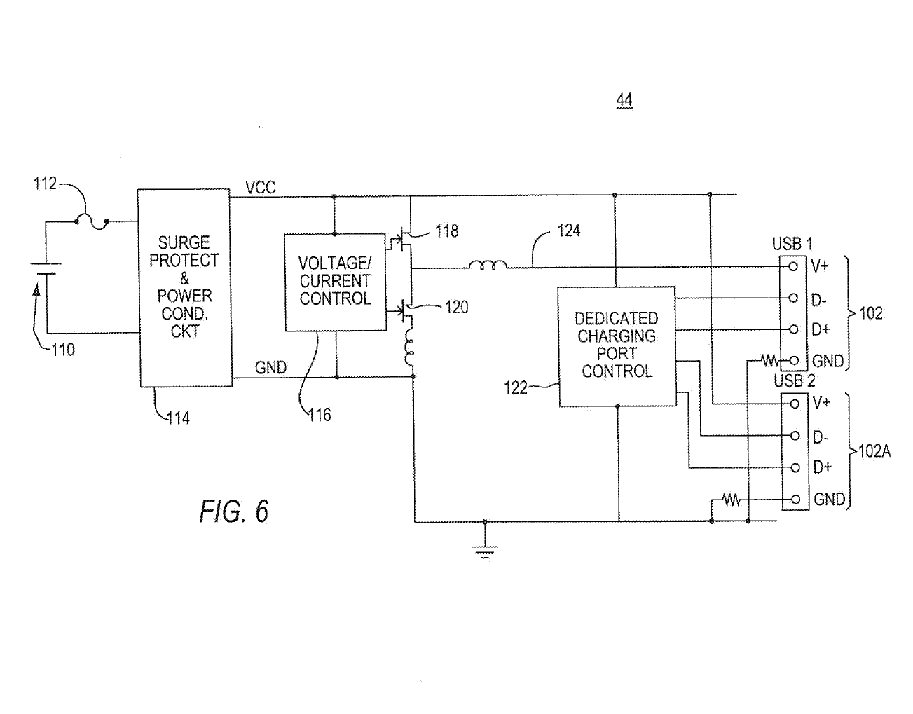

FIG. 6 shows a block diagram for circuit 44. Power to the circuit is provided from the automotive battery 110 through a fuse 112. A surge protection and power conditioning circuit 114 protects circuit 44 from power surges as well as instantaneous or spurious signals that are prevalent in motor vehicles. Adapter 100 may be used to provide simply power to a user device (not shown), in which case the the jacks 102, 102A could be connected straight to the busses Vcc and ground. However, if the adapter 100 is used for a charger as well, then it must be able to provide a higher current level and at a controlled nominal voltage. This charging current is provided by a voltage and current control circuit 116 cooperating with two FET switches 118, 120 as shown. The voltage and current control circuit may be implemented using an IC such as A2201V available from TI. This IC provides a dual channel constant voltage/constant current regulator. Its input can vary widely from 8 to 36 VDC and its output is regulated so that it does not deviate from its nominal output by more than ±1% for the voltage and ±4% and is able to up to 4 A.

Moreover, if the adapter is functioning as a charger, various USB standards also require certain control signals to be present and exchanged with the respective device through the D+ and D− pins . The necessary signals to these pins are provided by a dedicated charging control circuit 122. This circuit may be implemented using an IC such as a TOS2513 available from Texas Instruments. The IC monitors the data lines D= and D− independently on each of the jacks 102, 102A and automatically provides the correct signals on these data lines to enable the adapter to charge these devices in accordance with various US and international standards.

Numerous modifications may be made to this invention, without departing from its scope as defined in the appended claims.

I claim:

1. An automotive adapter comprising:
a body sized and shaped to fit in the accessory socket of a vehicle, said body including connecting elements adapted to connect to battery terminals in the accessory socket and an output member for coupling to a power cord of an external device; and
a tab associated with said body, said tab being arranged and constructed to receive and secure the cord.

2. The adapter of claim 1 wherein said cord is hardwired to said output member.

3. The adapter of claim 1 wherein said output member is a jack and said cord includes a first end with a plug arranged and constructed to mate with the jack.

4. The adapter of claim 1 wherein said tab is formed with a hole receiving said cord.

5. The adapter of claim 1 wherein said hole is sized and shaped to allow the cord to be selectively removable from said hole.

6. An automotive adapter using power from a motor vehicle, said motor vehicle having an accessory socket, said adapter comprising:
an elongated body having a front end and rear end joined to said front end by an external wall, said elongated body supporting an electrical output through which an external device can be charged through a cord; and
a tab supported by said body, said tab being generally flat and being formed with an opening receiving said cord, said tab being arranged and constructed to support the cord while the adapter is inserted into the accessory socket.

7. The adapter of claim 6 wherein said hole has an elongated shape.

8. The adapter of claim 7 wherein said elongated shape is arranged along a longitudinal body parallel to said external wall.

9. The adapter of claim 8 wherein said hole includes a central portion, said central portion being round.

10. The adapter of claim 9 wherein said cord is a ribbon cord.

11. The adapter of claim 9 wherein said cord has a generally round cross section.

12. The adapter of claim 9 further comprising a slit extending to said hole and arranged for inserting the cord into said hole.

13. The adapter of claim 6 wherein said cord is hard-wired to said electrical output.

14. The adapter of claim 6 wherein said electrical output includes a jack and the cord includes a plug mating with said jack.

15. A adapter for delivering charging current to a device through a cord, said cord having one of a round and a flat cross section, comprising:
an elongated body having front end, a rear end and an external wall extending between said front and said rear ends, said body having generally cylindrical shape selected to fit into the accessory socket of a motor vehicle;
an electrical circuit disposed in said elongated body receiving input current from the motor vehicle at a first voltage and selectively generating an output current at a second voltage;
an electrical output disposed on said body and adapted to receive said output current and to deliver said output current to the cordp; and
a tab attached to said body and being formed with an elongated hole defined between two end portions sized and shaped to form an interference fit with the cord having the flat cross-section, said elongated hole further including central portions arranged and constructed to form an interference fit with the cord having a circular cross section.

16. The adapter of claim 15 wherein said tab is disposed at said rear end.

17. The adapter of claim 16 wherein said tab is generally flat.

18. The adapter of claim 17 wherein said rear end is generally flat and coplanar with said tab.
